(19) United States
(12) Patent Application Publication
(10) Pub. No.: US 2018/0092390 A1
(43) Pub. Date: Apr. 5, 2018

(54) DRY BARBEQUE MIX THICKENABLE WITHOUT HEATING

(71) Applicant: The Clorox Company, Oakland, CA (US)

(72) Inventors: Michael Hershkowitz, Pleasanton, CA (US); Amanda Facelle Varellas, San Francisco, CA (US); Ritu Mishra, Pleasanton, CA (US); Clarissa Koga, Pleasanton, CA (US); Hubert Chan, Pleasanton, CA (US); Elizabeth L. Donald, Pleasanton, CA (US)

(21) Appl. No.: 15/718,508

(22) Filed: Sep. 28, 2017

Related U.S. Application Data
(60) Provisional application No. 62/402,596, filed on Sep. 30, 2016.

(51) Int. Cl. A23L 27/14; A23L 27/60; A23L 27/40; A23L 29/219; A23L 29/262; A23L 13/40

(52) U.S. Cl. CPC A23L 27/14; A23L 27/60; A23L 27/45; A23V 2002/00; A23L 29/262; A23L 13/428; A23L 29/219

(57) ABSTRACT

A dry mixture of tomato powder, vinegar powder, and a modified food starch (e.g., hydroxypropyl distarch phosphate) capable of thickening upon addition of liquid, without requiring heating, is disclosed. The dry mixture may be employed as a dry rub, or may be mixed with a liquid of the consumer's choice (e.g., water, beer, wine, bourbon, soda, pineapple juice, other juice, vinegar, or the like). Upon such mixing, and without application of heat, the resulting mixture will spontaneously thicken to have viscosity and other rheological characteristics similar to bottled barbeque sauces, which are thickened with application of heat during formulation, e.g., before bottling.

### CROSS-REFERENCE TO RELATED APPLICATION

This application claims the benefit of U.S. Provisional Patent Application Ser. No. 62/402,596 filed on Sep. 30, 2016, entitled DRY BARBEQUE MIX THICKENABLE WITHOUT HEATING, which is incorporated herein in its entirety by reference.

### BACKGROUND OF THE INVENTION

### 1. The Field of the Invention

The present invention relates to dry packaged barbeque food products that can be used as a dry rub, but which is capable of thickening to form a sauce upon addition of a desired liquid, without any required heating.

### 2. Description of Related Art

Numerous barbeque sauce products are currently available that allow a consumer to apply such a sauce to a desired protein being cooked. Typical liquid sauce products that are available are thickened during preparation of the sauce, e.g., before bottling. In order to achieve such thickened sauce characteristics, such food products are typically heated as part of their preparation, in order to cause an included starch or other component in the food product formulation to thicken.

While such bottled barbeque products are very convenient for the consumer, they do not provide much customizability to the consumer. It would be advantageous to provide a barbeque food product that would be similarly convenient to use, but would provide increased customizability to the consumer.

### BRIEF SUMMARY

The present invention relates to dry packaged food mixtures, that can be thickened upon addition of a liquid thereto, without application of heat. By way of example, one such composition includes (a) one or more dry flavor components (e.g., comprising herbs, spices, dried fruits, or dried vegetables for providing flavor, (b) vinegar powder, (c) a modified food starch comprising a phosphated starch that has been ethoxylated and/or propoxylated, where the modified food starch is configured to thicken a resulting sauce upon mixing of the dry food mixture with a liquid, without requiring heating of the sauce in order to achieve such thickening. The ability to thicken a sauce under such conditions is unusual, and advantageous, as typically starches are not capable of gelatinization so as to thicken a sauce in which they are included, without application of heat. The present Applicant has found that the presently employed particular modified food starches are capable of providing a thickening function upon addition of a liquid thereto, without requiring any application of heat. An example of such a modified food starch is hydroxypropyl distarch phosphate (HDP).

Another embodiment is directed to a dry food mixture that is thickenable without heating, upon addition of liquid, where the food mixture composition comprises one or more dry flavor components comprising tomato powder and one or more of herbs, spices, dried fruits, or dried vegetables for providing flavor. The dry food mixture further includes sodium acetate, and a modified food starch comprising hydroxypropyl distarch phosphate (HDP), where the modified food starch is configured to thicken a resulting sauce upon mixing of the dry food mixture with a liquid, without requiring heating of the sauce in order to achieve such thickening.

The dry food mixture compositions advantageously allow a user to select whether to use the dry food mixture as a dry rub (e.g., for application to meat or other protein), or to mix the dry food mixture with a liquid to produce a sauce that is thickened without any heating. Thus, another embodiment of the present invention relates to a method for using the dry food mixture that is thickenable without heating upon addition of liquid. Such method may include providing a dry food mixture as described above, and selecting whether to apply the dry food mixture as a dry rub or to mix the dry food mixture with a liquid in order to produce the resulting sauce that is thickened without any heating, and then either (i) applying the dry food mixture to a protein food as a dry rub thereto, or (ii) mixing the dry food mixture with a liquid so as to form the resulting sauce which is thickened due to the presence of the modified food starch, without requiring any heating. Any desired liquid (e.g., aqueous liquid) may be used, e.g., including, but not limited to water, juice, beer, wine, bourbon, soda, and/or vinegar.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 shows viscosity data for exemplary dry mixtures according to the present invention once liquid has been added thereto, as compared to several comparative products; and

FIG. 2 shows viscoelastic behavior for G′ and G″ for the same compositions shown in FIG. 1.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to an “acid” includes one, two or more acids.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical formulation process, and may include values that are within 10%, within 5%, within 1%, etc. of a stated value. Furthermore, the terms “substantially”, “similarly”, “about” or “approximately” as used herein represent an amount or state close to the stated amount or state that still performs a desired function or achieves a desired result. For example, the term “substantially” “about” or “approximately” may refer to an amount that is within 10% of, within 5% of, or within 1% of, a stated amount or value.

Some ranges may be disclosed herein. Additional ranges may be defined between any values disclosed herein as being exemplary of a particular parameter. All such ranges are contemplated and within the scope of the present disclosure.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. Food safe materials may also include ingredients that are well established as safe, have adequate toxicological and safety pedigree, can be added to existing lists, or approved via a self-affirmation process. As the present compositions are food product formulations, they may include only materials that are “food safe”.

In the application, effective amounts are generally those amounts listed as the ranges or levels of ingredients in the descriptions, which follow hereto. Unless otherwise stated, amounts listed in percentage (“%'s”) are in weight percent (based on 100% active) of the salad dressing formulation. With respect to the salad dressing formulation, the terms “salad dressing formulation”, “salad dressing composition” and “salad dressing product” are used interchangeably herein.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

In an aspect, the present invention is directed to mixtures of dry components that can be used as a dry rub (e.g., to add flavor and/or texture to protein, such as to meat) or, when combined with a liquid, a thickened sauce for topping or dipping of meat, vegetables, potatoes, or other foods may be provided. The dry blend, when combined with liquid (e.g., including, but are not limited to, water, juice, beer, wine, bourbon, soda, vinegar) achieves viscosity and rheological properties of a thickened sauce (e.g., a barbeque sauce). In other words, if the user chooses to add a liquid to the dry blend and create a thickened sauce, the sauce has viscosity and rheological properties similar to bottled barbeque sauce food products, but without actually requiring any heating of the mixture of the dry blend and liquid after liquid addition.

By way of example, when prepared as a thickened sauce, the food product composition may have a viscosity of at least about 500 cP, at least about 1,000 cP, at least about 3,000 cP, at least about 5,000 cP, from about 1,000 cP to about 100,000 cP, from about 1,000 cP to about 50,000 cP, or from about 1,000 cP to about 10,000 cP. Such measurement of viscosity may be taken at a desired shear rate, e.g., at a shear rate of 10 s⁻¹. Other rheological characteristics of the food product composition once mixed with the desired liquid may be comparable to those of a bottled barbeque food product (e.g., comparable to original and other KC MASTERPIECE® barbeque sauces).

### III. Exemplary BBQ Mix Formulations

The dry rub includes components that provide flavor (e.g., herbs, spices, dried fruits and/or vegetables) and/or texture (adding viscosity and “body” to a resulting sauce). Components useful as processing aids may also be present. For example, typical components may include: tomato powder (commonly used as a BBQ sauce base), vinegar powder (e.g., sodium acetate), for adding acidity and taste, and a specifically selected modified food starch capable of thickening so as to add viscosity and “body” to a resulting sauce without requiring heating. An example of such a modified starch exhibiting such properties is hydroxypropyl distarch phosphate (HDP). For example, such starch is capable of quickly thickening into a sauce having viscosity and viscoelastic characteristics similar to typical bottled barbeque sauces.

By way of further explanation, the dry mixture, when mixed with a desired liquid is able to thicken without requiring the user to apply heat through a stovetop, a microwave, or the like. For example, in order to thicken a typical sauce, including a starch that thickens upon application of heat, a roux (mixture of fat (e.g., butter) and starch or a flour) may be formed, and heat may be applied so as to raise the temperature of the roux and other components of the sauce to about 160° F. to about 200° F., e.g., for a period of time from about 1 to about 30 minutes. Such heat causes such conventional starches to gelatinize, where such gelatinization would not occur otherwise. The present compositions do not require such heating, but will thicken by simply mixing the dry mixture with a desired liquid, e.g., at ambient temperatures of typically 100° F. or below (e.g., more typically from about 65° F. to about 80° F.).

Hydroxypropyl distarch phosphate (HDP) is a modified starch, e.g., prepared by treating a starch with propylene oxide and phosphoric acid. For example, the starch may be propoxylated or ethoxylated, and/or phosphated. The starch may be derived from any desired grain or flour. In some embodiments, corn, maize, and/or malted barley flour may be employed. HDP starch is typically used in frozen foods, as providing enhanced freeze-thaw properties, although it has not traditionally been used to thicken a sauce as contemplated herein. Modification as described above also provides the starch with resistance characteristics to enzyme degradation and digestion. As a result, this modified starch is a resistive starch, making it more difficult to digest. As a result, it also contributes less to the caloric content of a food into which it is incorporated than a similar starch that does not exhibit such resistive properties. An example of a suitable HDP starch is available under the tradename ULTRA-TEX 4, from Ingredion, headquartered in Westchester, Ill.

One or more cellulosic gums may also be included, e.g., also for thickening and to provide added “body”. For example, xanthan gum, guar gum, locust bean gum, carrageenan gum and/or other gums may be included.

As described above, traditional barbecue sauces of comparable thickness and viscosity require heat to prepare. Typical dry products that can be combined with liquids do not achieve the rheological properties of a thickened sauce. The described dry blend is combined with any liquid and, without the addition of heat, produces a sauce of comparable thickness and viscosity to other sauces. For example, mixing the dry blend with a desired liquid (at a given amount thereof) results in a sauce that is thicker than sauce made with other starches, without application of heat, or that is made with cold swelling starches. The dry blend can be used as a dry rub or combined with any desired liquid to create a barbecue sauce intended for adding flavor to proteins like fish, chicken, beef, tofu, pork, or the like. A representative example of such a dry blend of spices and processing aids comprises herbs, spices, dried fruits, dried vegetables, sugar, salt, vinegar powder, tomato powder, xanthan gum and modified food starch (e.g., hydroxypropyl distarch phosphate).

The dry mixture may typically include from about 0.1% to less than 100% of the dry flavor components (herbs, spices, dried fruits, dried vegetables (e.g., tomato powder), sugar, salt, and vinegar powder). Such dry flavor components may comprise from about 0.5% to about 90%, from about 1% to about 90%, from about 5% to about 90%, from about 10% to about 90%, from about 20% to about 80%, or from about 25% to about 75% of the dry mixture. The dry mixture may typically include from about 0.1% to about 50% of the modified food starch (e.g., HDP) exhibiting the above described characteristics. HDP or another similarly characterized food starch may comprise from about 0.5% to about 50%, from about 1% to about 40%, from about 2% to about 30%, from about 3% to about 30%, from about 3% to about 25%, or from about 5% to about 25% of the dry mixture. The dry mixture may typically include from about 0.1% to about 50% of one or more cellulosic gums (e.g., xanthan gum). The one or more cellulosic gums may comprise from about 0.5% to about 50%, from about 1% to about 40%, from about 2% to about 30%, from about 3% to about 30%, from about 3% to about 25%, or from about 5% to about 25% of the dry mixture.

Exemplary methods of forming thickened barbeque sauces as described herein may include steps of simply emptying the contents (e.g., 2 oz) of the dry mixture (e.g., from a packet) into a bowl, and adding ¾ cup of a desired liquid (e.g., water, pineapple juice, other juice, coffee, beer, wine, bourbon, soda, vinegar or other food liquid), and mixing the dry mixture with the liquid until well blended (e.g., with a whisk). Immediately upon such mixing, because of the inclusion of the specifically configured starch component, the result becomes a thickened sauce, having viscosity and other rheological characteristics comparable to a bottled barbeque sauce (e.g., original or other KC MASTERPIECE® barbeque sauces). While not necessary, if the mixed barbeque sauce is allowed to sit (e.g., for about an hour) before use, it will continue to thicken, exhibiting relatively thicker, more “firm” and greater “body” characteristics. For example, one may allow such a mixed sauce to sit for at least about 10 minutes to about 3 hours, from about 15 minutes to about 2 hours, or from about 30 minutes to about 90 minutes (e.g., about 1 hour).

As described herein, instead of combining with a liquid to form a sauce, the dry mixture may be employed as a dry rub that may be applied to the meat or other protein. For example, one may empty the contents of the packet into a bowl, optionally add any desired fresh ingredients (e.g., parsley cilantro, minced garlic, chopped jalapeno or other peppers, etc.), mix until well blended, and pat the dry rub onto the meat or other protein. Such a dry rub may be applied to the protein, and allowed to sit (e.g., covered) for several hours (e.g., overnight) in the refrigerator to increase the flavor.

The dry mixture may be used to make a marinade, e.g., thinner than a sauce by increasing the amount of liquid added to the dry mixture. For example, 1 cup (e.g., about 30% more) liquid may be added to the dry mixture, the mixture of liquid and dry components may be blended, and the protein or other food item to be seasoned may be allowed to marinate in the prepared marinade for about 30 minutes or more (e.g., in the refrigerator).

While the above examples illustrate a ratio of dry mixture to liquid of about 2 oz dry mixture to about 6-8 oz liquid, it will be appreciated that somewhat more or somewhat less liquid may be mixed with the dry mixture to prepare a desired sauce. For example, the weight ratio of the dry mixture to the selected liquid may be from about 1:1 to about 1:5, from about 1:2 to about 1:5, from about 1:2 to about 1:4, or from about 1:2 to about 1:3, or from about 1:3 to about 1:4. The recommended ratio and resulting viscosity of the prepared barbeque sauce may depend on the weight fraction of HDP or similar starch included in the dry mixture, among other factors.

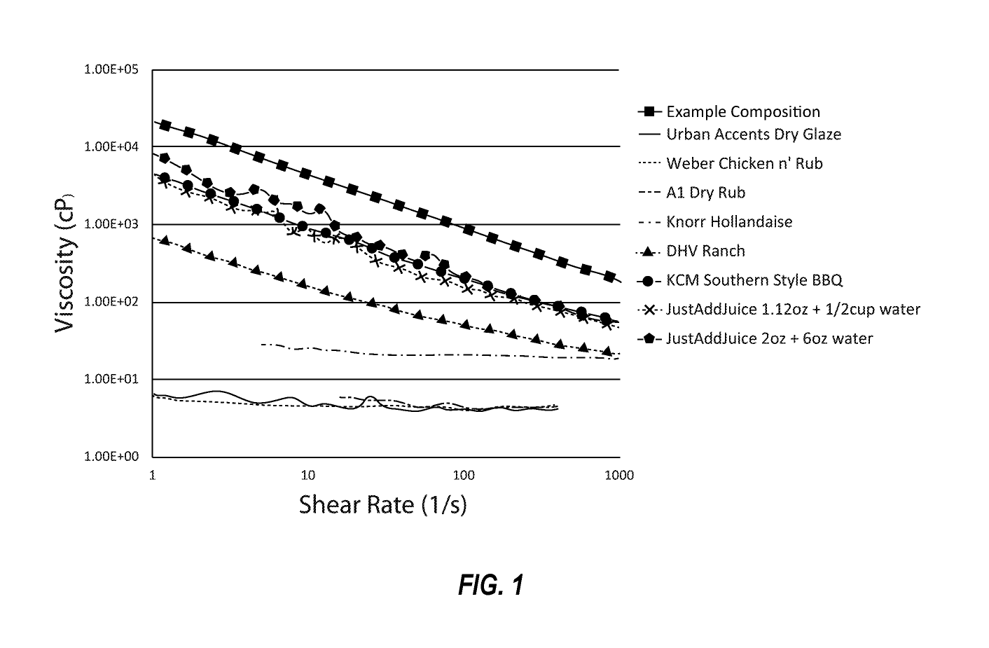

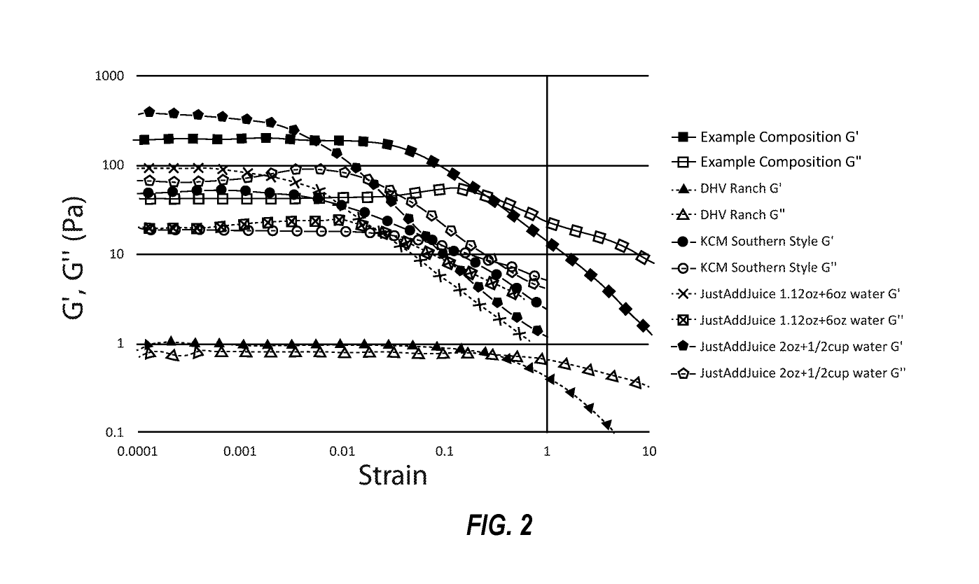

FIGS. 1 and 2 show comparative testing data showing viscosity and viscoelastic behavior of an example composition as compared to other products. All rheological measurements were conducted on an Anton Paar MCR302 rheometer using a concentric cylinder geometry. The flow behavior was probed by measuring viscosity as a function of shear rate at 25° C. This provided insight into the how the thickness of each sample might vary under different applications. For example, a relatively low shear rate results describe behavior when gently tilted in its container or its ability to cling to a food item, results at a higher shear rate describe its behavior during spreading or stirring. In addition, oscillatory measurements were conducted by measuring the elastic modulus (G′) and viscous modulus or loss modulus (G″) as a function of strain at a constant oscillatory frequency (1 Hz at 25° C.). These measurements provided insight into the overall viscoelasticity of the products—how “solid-like” vs. “liquid-like” each sample was, and how “brittle” the solid-like structure might be in each case.

FIG. 1 shows viscosity data for the tested compositions (e.g., where 2 oz of the example dry mix composition was mixed with 6 oz of water). Of the tested compositions, the Urban Accents dry glaze, the Weber chicken n'rub, and the A1 dry rub were all just very runny, low viscosity Newtonian fluids, with viscosity values of less than 10 centipoise at all measured shear rates. Such products themselves provide only negligible thickening as compared to water, and do not significantly affect rheology. The Knorr hollandaise was also a Newtonian fluid, but significantly thicker than the above referenced sauces. All such products were of sufficiently low viscosity (i.e., very runny) so that they phase separate due to gravity within minutes.

The DHV Ranch, KCM southern style, the two JustAddJuice products, and the exemplary composition are clearly different rheologically from the other samples, in that they are non-Newtonian. The higher viscosities at low shear rates allows for them to resist phase separation for relatively long periods of time (so as to be useful as barbeque spreads, sauces, dips, and the like). The exemplary composition exhibited higher viscosity than all other tested samples across all shear rates.

FIG. 2 shows results for elastic modulus (G′) and viscous modulus or loss modulus (G″) for several tested compositions. For such tested yield stress fluids, oscillatory strain measurements can be made to measure such viscoelasticity characteristics. G′ corresponds somewhat to solid-like characteristics, while G″ corresponds somewhat to liquid-like characteristics. Relatively higher G′ plateau values (which are observed to the left of FIG. 2, before a decrease accelerates at increasing strain) corresponds to greater structural strength. Another key characteristic is the crossover point, where G′ and G″ crossover one another. Later (at higher strain, and/or higher Pascal value) crossover points correspond to greater resistance in the product to breakup of the gel network. The JustAddJuice samples are relatively strong, and with viscosity values that are perhaps somewhat similar to the exemplary composition, but these compositions are very “brittle”, with a crossover point near a strain value of 0.01. The present compositions are more resistant to breakup of the gel network within the sauce, as they have a significantly later crossover value.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A dry food mixture that is thickenable without heating upon addition of liquid, the food mixture comprising:
(a) one or more dry flavor components comprising herbs, spices, dried fruits, or dried vegetables for providing flavor;
(b) vinegar powder;
(c) a modified food starch comprising a phosphated starch that has been ethoxylated and/or propoxylated, the modified food starch being configured to thicken a resulting sauce upon mixing of the dry food mixture with a liquid, without requiring heating of the sauce in order to achieve such thickening.

2. The dry food mixture of claim 1, wherein the vinegar powder comprises sodium acetate.

3. The dry food mixture of claim 1, wherein the dry food mixture further comprises a cellulosic gum.

4. The dry food mixture of claim 3, wherein the cellulosic gum comprises at least one of xanthan gum, guar gum, locust bean gum, or carrageenan gum.

5. The dry food mixture of claim 3, wherein the cellulosic gum comprises from about 5% to about 25% of the dry food mixture.

6. The dry food mixture of claim 1, wherein the modified food starch comprises hydroxypropyl distarch phosphate (HDP).

7. The dry food mixture of claim 6, wherein the modified food starch consists essentially of hydroxypropyl distarch phosphate (HDP).

8. The dry food mixture of claim 6, wherein the modified food starch consists of hydroxypropyl distarch phosphate (HDP).

9. The dry food mixture of claim 6, wherein the hydroxypropyl distarch phosphate (HDP) comprises from about 5% to about 25% of the dry food mixture.

10. The dry food mixture of claim 1, wherein the dry flavor component comprises from about 25% to about 75% of the dry food mixture.

11. The dry food mixture of claim 1, wherein the resulting sauce formed upon mixing of the dry food mixture with the liquid has a viscosity of at least 10,000 cps at a shear rate of 1 s⁻¹.

12. The dry food mixture of claim 1, wherein the resulting sauce formed upon mixing of the dry food mixture with the liquid has an elastic modulus (G′) of at least 10 Pa at a strain of 1.

13. The dry food mixture of claim 1, wherein the resulting sauce formed upon mixing of the dry food mixture with the liquid has a viscous modulus (G″) of at least 10 Pa at a strain of 1.

14. The dry food mixture of claim 1, wherein the resulting sauce formed upon mixing of the dry food mixture with the liquid has a crossover point of elastic modulus (G′) with viscous modulus (G″) that occurs at at least 10 Pa and at a strain of at least 0.1.

15. A dry food mixture that is thickenable without beating upon addition of liquid, the food mixture comprising:
(a) one or more dry flavor components comprising tomato powder and one or more of herbs, spices, dried fruits, or dried vegetables for providing flavor;
(c) sodium acetate;
(d) a modified food starch comprising hydroxypropyl distarch phosphate (HDP), the modified food starch being configured to thicken a resulting sauce upon mixing of the dry food mixture with a liquid, without requiring heating of the sauce in order to achieve such thickening.

16. The dry food mixture of claim 15, wherein the modified food starch consists of hydroxypropyl distarch phosphate (HDP).

17. A method for using a dry food mixture that is thickenable without heating upon addition of liquid, the method comprising:
(a) providing the dry food mixture, the dry food mixture comprising:
(i) one or more dry flavor components comprising herbs, spices, dried fruits, or dried vegetables for providing flavor;
(ii) vinegar powder;
(iii) a modified food starch comprising a phosphated starch that has been ethoxylated and/or propoxylated, the modified food starch being configured to thicken a resulting sauce upon mixing of the dry food mixture with a liquid, without requiring heating of the sauce in order to achieve such thickening;
(b) selecting whether to apply the dry food mixture as a dry rub or to mix the dry food mixture with a liquid in order to produce the resulting sauce which is thickened without any heating; and
either:
(b1) applying the dry food mixture to a protein food as a dry rub thereto; or
(b2) mixing the dry food mixture with a liquid, so as to form the resulting sauce which is thickened due to the presence of the modified food starch, without requiring any heating.

18. The method of claim 17, wherein the dry food mixture is mixed with the liquid, the liquid comprising at least one of water, juice, coffee, beer, wine, bourbon, soda or vinegar.

19. The method of claim 17, wherein the protein food comprises at least one of fish, chicken, beef, tofu or pork.

20. The method of claim 17, wherein the modified food starch comprises hydroxypropyl distarch phosphate (HDP).
